(19) United States
(12) Patent Application Publication
(10) Pub. No.: US 2024/0226845 A1
(43) Pub. Date: Jul. 11, 2024

(54) DIPODAL SILANE BONDED SORBENTS FOR SOLID PHASE EXTRACTION AND USE THEREOF FOR OLIGONUCLEOTIDE EXTRACTION

(71) Applicant: Waters Technologies Corporation, Milford, MA (US)

(72) Inventors: Matthew Lauber, North Smithfield, RI (US); Nicole Lawrence, Stafford Springs, CT (US); Daniel Walsh, Danvers, MA (US); Jessica Field, Webster, MA (US)

(73) Assignee: Waters Technologies Corporation, Milford, MA (US)

(21) Appl. No.: 18/407,660

(22) Filed: Jan. 9, 2024

Related U.S. Application Data
(60) Provisional application No. 63/479,483, filed on Jan. 11, 2023.

(51) Int. Cl. B01J 20/10; B01J 20/28; B01J 20/30; G01N 21/33; G01N 30/02; G01N 30/88

(52) U.S. Cl. CPC B01J 20/103; B01J 20/28016; B01J 20/28045; B01J 20/3085; G01N 21/33; G01N 30/88; G01N 2030/027; G01N 2030/8827

(57) ABSTRACT

Provided herein are compositions, kits and methods that may be useful for improving the efficiency of solid phase extraction to separate oligonucleotides from a complex matrix. Particularly, the present technology relates to a sorbent material including porous particles, the surface of which is modified with a ligand that includes one or more bridging alkyl substituted amines and at least two siloxyl terminal groups.

### RELATED APPLICATIONS

This application claims priority and benefit to U.S. Provisional Patent Application No. 63/479,483, filed on Jan. 11, 2023, and entitled “DIPODAL SILANE BONDED SORBENTS FOR SOLID PHASE EXTRACTION AND USE THEREOF FOR OLIGONUCLEOTIDE EXTRACTION”, the content of which is incorporated herein by reference in its entirety.

### FIELD OF THE TECHNOLOGY

The present technology generally relates to compositions, kits and methods that may be used for performing solid phase extraction including oligonucleotide extraction. Particularly, the present technology relates to a sorbent material including porous particles having their surfaces modified with a ligand which includes one or more bridging alkyl substituted amines and at least two terminal siloxyl groups. The ligand of the present disclosure includes less than 16 carbon atoms.

### BACKGROUND

Oligonucleotides are fragments of nucleic acids, such as intermediate degradation products of DNA and RNA or microRNAs, which regulate processes in biological systems. Their expression may be deregulated when diseases are developed. Therefore, oligonucleotides are proposed as a diagnostic and prognostic tool for various diseases. Oligonucleotides are also being developed as therapeutic drugs for a wide range of disease conditions. Accordingly, extraction of oligonucleotides from complex samples is required for research and clinical diagnostic applications.

However, the biological sample extraction from complex biological matrices such as plasma, blood, urine and tissue remains a formidable challenge in developing quantitative analytical methods for oligonucleotides. The polyanionic nature of oligonucleotides ensures that these compounds will be strongly bound to plasma proteins in addition to other matrix components. Successful bioanalytical sample preparation hinges on the difficult process of separating the oligonucleotide from the matrix. Protein precipitation, protein digestion, liquid-liquid extraction, reversed phase solid phase extraction (SPE), strong anion exchange SPE, and combinations of them have been reported to extract oligonucleotides from biological matrices. Among them, the most common approach involves a multistep liquid-liquid extraction followed by an additional SPE to further clean up the sample. Unfortunately, these methods either have low recoveries or present potential problems for applications with chromatography due to the large amount of matrix substances in the resulting solutions.

### SUMMARY

One of the objectives of the present technology is to provide SPE sorbents with improved chemical stability in terms of maintaining the integrity in aggressive environments (e.g., higher pH (>10)).

In accordance with some aspects, the present disclosure pertains to sorbents that can offer various advantages over conventional silica-based materials, including significantly improved chemical and/or hydrolytic stability. Improved hydrolytic stability may have significant impact on performance of the sorbent.

The sorbents of the present technology possess improved high pH stability, which facilitates the use of higher pH (>10) eluents for high analyte recovery and selective extraction of oligonucleotides from biofluid matrices. Accordingly, one of the objectives of the present technology is to improve the analyte recovery and/or the reproducibility of oligonucleotide extraction from complex biofluid matrices.

The present technology allows selective extraction of oligonucleotides from complex biofluid matrices.

Selective capturing of oligonucleotides from complex matrices may lead to decrease in the number of steps in protein purification processes, thereby providing increases in efficiency and lowering overall costs.

In accordance with some aspects, the present disclosure is directed to a sorbent material for performing solid phase extraction. In multiple embodiments, the surface of the sorbent material of the present technology comprises dipodal or tripodal siloxyl groups that are bridged by a moiety including one or more substituted amines, e.g., secondary or tertiary amines.

In one aspect, the present disclosure is directed to a sorbent material for performing solid phase extraction. The sorbent material in accordance with this aspect comprises porous particles having a mean particle size greater than 5 μm and less than 100 μm, wherein the surface of the porous particles is modified with a ligand that includes one or more bridging alkyl substituted amines and at least two terminal siloxyl groups.

The above aspects may include one or more of the following features: in some embodiments, the ligand comprises less than 20 carbon atoms, less than 16 carbon atoms, less than 14 carbon atoms, less than 12 carbon atoms, or less than 10 carbon atoms.

In some embodiments, the terminal siloxyl group is derived from a bis, trifunctionally activated silylpropyl N-methylamine silanization reagent. In some embodiments, the terminal siloxyl group is derived from bis(3-trimethoxysilylpropyl)-N-methylamine.

In some embodiments, the sorbent material maintains hydrolytic stability over a pH range of about 8.5 to about 12.

In some embodiments, the one or more bridging alkyl substituted amines have one or more pKa values (e.g., first pKa, second pKa . . . ) in a range of about 8 to about 12, about 9 to about 12, about 10 to about 12. In one embodiment, the one or more bridging alkyl substituted amines have one or more pKa values greater than 7 and less than 10.5.

In some embodiments, the porous particles are porous silica particles. In one embodiment, the porous silica particles are calcined porous silica particles. In one embodiment, the porous particles are porous silica/organic hybrid particles. In some embodiments, the porous particles have an average pore diameter of between 450 Å and 1000 Å, between 300 Å and 1000 Å, between 150 Å and 1000 Å, between 150 Å and 500 Å, between 200 Å and 400 Å.

The above aspects may include one or more of the following features.

In some embodiments, the ligand surface concentration is from about 0.05 μmol/m² to about 5.0 μmol/m².

In one aspect, provided herein is a solid phase extraction device that contains the sorbent material of the present disclosure according to above aspects and embodiments.

In another aspect, provided herein is a kit comprising the sorbent material of the present disclosure according to above aspects and embodiments, and instructions for use, wherein the instructions are for use with a solid phase extraction device for the extraction of a nucleic acid from a biofluid.

According to multiple embodiments of the present disclosure, the sorbent material provided herein is useful for nucleic acid extraction from a biological sample. In some embodiments, the nucleic acid has a size ranging from a 10 mer to a 200 mer.

In another aspect, the present technology is directed to a method of performing solid phase extraction comprising: (a) loading a sample fluid comprising one or more target oligonucleotides and at least one non-target component onto a sorbent material comprising porous particles having a mean particle size greater than 5 μm and less than 100 μm, wherein the surface of the porous particles is modified with a ligand that includes one or more bridging alkyl substituted amines and at least two terminal siloxyl groups, wherein the ligand comprises less than 16 carbon atoms, wherein at least one of the target oligonucleotides is retained by the sorbent; (b) flowing one or more washing solutions through the sorbent material, wherein the washing solutions remove at least one non-target component from the sorbent material while leaving at least one of the target oligonucleotides retained on the sorbent material; and (c) flowing one or more elution solutions though the sorbent material, wherein at least one of the target oligonucleotides retained on the sorbent material is released into one or more eluent solutions.

In some embodiments, after flowing the one or more elution solutions through the sorbent material, subjecting the one or more eluent solutions to liquid chromatography, mass spectrometry (MS), ultraviolet-visible spectroscopy, or combinations thereof.

In some embodiments, the one or more washing solutions comprises a partially aqueous organic solvent solution containing either methanol, ethanol, or tetrahydrofuran.

In some embodiments, the one or more elution solutions have a pH ranging from 8.5 to 12.

In some embodiments, the one or more elution solutions comprise a di, tri or tetravalent acid.

In some embodiments, the one or more elution solutions comprise one or more bases selected from an organic amine, ammonium bicarbonate, ammonium hydroxide, or ammonium acetate. In one embodiment, the one or more elution solutions comprise the organic amine triethylamine (TEA).

In some embodiments, the sample comprises biological fluids selected from whole blood samples, blood plasma samples, serum samples, oral fluids, cerebrospinal fluids, fecal samples, nasal samples, and urine, biological tissues such as liver, kidney and brain tissue, tissue homogenates, cells, or cell culture supernatants. In one embodiment, one or more target analyte is a double-stranded RNA, single-stranded RNA, single-stranded DNA, double-stranded DNA, double-stranded RNA/DNA hybrid, synthetic RNA, synthetic DNA or combination therefore with a size ranging from a 10 mer to a 200 mer.

In some embodiments, the porous particles are porous silica particles. In some embodiments, the porous silica particles are calcined porous silica particles. In other embodiments, the porous particles are porous silica/organic hybrid particles.

In one aspect, the present disclosure is directed to a sorbent material for performing solid phase extraction, the sorbent material comprising porous silica particles having an average pore diameter greater than 200 Å and less than 400 Å and a mean particle size greater than 5 μm and less than 25 μm, wherein an exterior surface of each of the porous silica particles is modified with bis(3-trimethoxysilylpropyl)-N-methylamine.

The sorbent of the present technology leverages the use of dipodal or tripodal siloxyl groups that are bridged by a moiety that includes one or more substituted amines to improve extraction cleanliness and efficiency of oligonucleotides from complex samples.

### BRIEF DESCRIPTION OF DRAWINGS

The technology will be more fully understood from the following detailed description taken in conjunction with the accompanying drawings, in which:

FIG. 1A-FIG. 1F show chromatograms of Material 1 (FIG. 1A), Material 2 (FIG. 1B), Material 3 (FIG. 1C), Material 4 (FIG. 1D), Material 5 (FIG. 1E), and Material 6 (FIG. 1F) obtained upon testing chemical stability of weak anion exchange solid phase extraction (SPE) sorbents as subjected to pH 8.5 mobile phase conditions. The solid fill traces represent the second chromatogram obtained from sequential trimethylphenylammonium (TMPA) isocratic separations, and the unfilled traces show the twenty fifth chromatogram obtained at the endpoint of stability testing.

FIG. 2 shows plots of TMPA retentivity as a function of exposure to pH 8.5 conditions.

FIG. 3A and FIG. 3B show size-exclusion chromatography with UV absorbance detection (SEC-UV) chromatograms for eluate (FIG. 3A) collected from SPE performed with material 2 and for control standard (FIG. 3B).

FIGS. 4A and 4B show recovery (FIG. 4A) of 20-mer T7 promoter polymerase chain reaction (PCR) primer and the relative composition (FIG. 4B) of SPE eluates.

FIG. 5A and FIG. 5B show the recovery (FIG. 5A) of 20-mer T7 promoter PCR primer and the relative composition (FIG. 5B) of SPE eluates collected from SPE performed with materials 14, 13, 11, 12 and 2.

FIG. 6 shows ion-pairing reversed phase liquid chromatography of Trecovirsen as extracted by weak anion exchange SPE using Materials 1 through 6.

### DETAILED DESCRIPTION

Oligonucleotides (OGNs) have a wide range of applications, including research, disease diagnosis, and therapy. OGNs used as therapeutics have high growth potential. They are used as starters in polymerase chain reactions, allowing for gene expression studies or probes for DNA sequencing, characterization, and tracking nucleic acids in biological systems. They are clinically tested as potential therapeutics in various diseases. Accordingly, there has been a significant breakthrough in this field in the past years.

Therefore, analysis of OGNs is important for impurity determination, degradation, or biotransformation product analysis. Medical utilization of OGNs also requires analysis, e.g., the detection of interference RNA (RNAi) concentration changes helps in disease diagnosis, while the quantitative and qualitative determination of oligonucleotides is a crucial aspect of clinical studies for their potential application as drugs.

The most commonly used techniques for analysis of OGNs are liquid chromatography (LC) and solid phase extraction (SPE). Both techniques utilize adsorbents based on interactions between the analyte, liquid phase, and solid phase. Stronger interaction between OGNs and adsorbent surfaces affects stronger retention and, at the same time, may cause higher resolution or extraction efficiency. Thus, an appropriate selection of adsorbents is an essential aspect of OGN separation and extraction.

Commercially available SPE devices for nucleic acid extraction include media that retain analytes by hydrogen bonding, ion pairing reversed-phase, and ion exchange retention mechanisms. Ion exchange techniques have been applied that entail the use of salt concentration and pH changes. SPE cartridges using a weak anion exchange (WAX) mechanism have been widely used to practice pH-based elution. The surface of a WAX sorbent contains one or more anionic moieties that has a pKa in the range of 5 to 12. This charge-bearing ligand is protonated below its pKa and is deprotonated above its pKa. To perform SPE for OGNs extraction, the WAX particles are generally first charged at low pH (e.g., below pKa value of the one or more anionic moieties) to enhance binding with the negatively charged phosphorothioate backbone of OGNs. When the pH is increased, the particles are neutralized, and the oligonucleotides are released from the cartridge.

Commercial WAX sorbents are (nearly) exclusively based on polymeric compositions; most especially for any applications in which pH-based elution is called for. Oasis WAX (commercially available from Waters Corporation, Milford, MA) is an example of a WAX sorbent. Conventional method development approaches call for Oasis WAX to be used with neutral or acidic load conditions followed with a 5% ammonium hydroxide eluent. Another example of a polymeric WAX sorbent is Clarity OTX (available from Phenomenex, Torrance, CA).

Several silica-based WAX sorbents are also available, but manufacturer specifications suggest that the sorbents be limited to use with solutions having pH values of less than 9. Qiagen anion exchange resin is one such example (available from Qiagen, Venlo, Netherlands). Manufacturer information on the sorbent recommends using an elution solution having pH value of 9.5 or below. However, using a silica-based sorbent, which is not resistant to high pH, can decrease recovery and cause ion suppression with the generation of silicates. On a polymeric material, there is increased secondary reversed-phase interactions.

Accordingly, it is essential to utilize appropriate sorbent materials for SPE of oligonucleotides to improve separation ability, selectivity, and extraction efficiency.

The technology described herein addresses the need for improved high-pH elution of OGNs from unique WAX sorbents that are functionalized (modified) with dipodal or tripodal silanes bearing one or more substituted amine(s) having pKas in the range of 5 to 12, desirably 6 to 11, or more desirably 7 to 10.5.

In some embodiments, the dipodal silyl modification includes a bridging tertiary amine that is sterically constrained from attacking its own base particle. In this way, it exhibits significantly improved chemical stability versus traditional silica WAX sorbents that are based on amino propyl, diethylamino, and primary/secondary amine type chemistries. In turn, the sorbents of the instant disclosure provide high pH stability even when used with silica base particles, which facilitates the use of higher pH (>10) eluents for high analyte recovery and selective extraction of oligonucleotides from biofluid matrices.

Detailed descriptions of various concepts related to, and embodiments of, compositions, kits and methods for extracting oligonucleotides from a sample matrix using, inter alia, a sorbent material including dipodal or tripodal siloxyl groups that are connected through a moiety that includes one or more substituted amine(s) are provided below.

It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

The present disclosure provides novel and improved processes for extracting one or more oligonucleotide(s) of interest, e.g., RNAi from a sample matrix including one or more oligonucleotide(s) of interest. In certain instances, the sorbents and methods disclosed decreases the number of steps that may be used in a solid phase extraction of OGNs, thereby reducing the overall operational costs, and saving time.

### Definitions

As used herein, the term “approximately” or “about” means+/−10% of the recited value.

As used herein, the term “includes” means includes but is not limited to, and the term “including” means including but not limited to.

As used herein, the term “sorbent,” or “sorbent material” refers to a material to which one or more components of the sample (e.g., oligonucleotides) adsorb. In some embodiments, the sorbent material of the present technology includes solid particles, preferably solid porous particles, e.g., solid silica or hybrid particles.

The terms “connected,” “conjugated,” “linked,” “attached,” “coupled,” and “tethered,” when used with respect to two or more moieties, means that the moieties are physically associated or connected with one another, either directly or via one or more additional moieties that serves as a linking agent, to form a structure that is sufficiently stable so that the moieties remain physically associated under the conditions in which the structure is used.

As used herein, the term “eluent” refers to a carrier portion of the mobile phase, such as a solvent or mixture of solvents with which a sample can be delivered in a chromatographic process.

As used herein, the term “eluate” refers to the material that emerges from or is eluted from a chromatographic process. To “elute” a molecule with an “eluent solution” (e.g., an oligonucleotide of interest or an impurity) from sorbent is meant to remove the molecule therefrom by altering the solution conditions such that buffer competes with the molecule of interest for binding to the sorbent. A non-limiting example is to elute a molecule from a sorbent by altering the pH of the buffer surrounding the sorbent.

As used herein the term “oligonucleotide” refers to a polymer sequence of two more nucleotides, including RNA, DNA, their analogs, including those having base modifications, sugar modifications or linkers used to modify the bioavailability, examples of which modifications include 2′-O-methoxyethyl, 2′-fluoro, phosphorothioate and or GalNAc modifications. Examples of oligonucleotides include antisense oligonucleotides (ASOs), small interfering RNAs (siRNAs), small hairpin RNAs (shRNAs), micro RNAs (miRNAs), messenger RNAs (mRNAs), and plasmids.

As used herein, the term “stationary phase” refers to the phase or portion that is fixed in place or stationary in a chromatographic process, such as a solid material within a column through which the mobile phase passes.

As used herein, the term “mobile phase” refers to a phase or portion that moves in a chromatographic method, such as by passing through a column, and it includes the sample and the eluent.

As used herein, the term “functionalized,” “modified” or “chemically modified” refers to a changed state or structure of a molecule of this technology. Molecules may be modified in many ways including chemically, structurally, and functionally.

As used herein, the terms “extracting,” “separating,” or “isolating,” as used interchangeably herein, refer to increasing the degree of purity of a target molecule e.g., a RNAi from a composition or sample matrix e.g., a solution comprising the target molecule and one or more impurities. Typically, the degree of purity of the target molecule is increased by removing (completely or partially) at least one impurity from the composition.

The sorbents, methods and kits provided herein are useful for solid phase extraction of oligonucleotides.

As used herein, and unless stated otherwise, the term “sample” refers to any composition or mixture that contains one or more oligonucleotide(s) of interest. Samples may be derived from biological or other sources. Biological sources include eukaryotic and prokaryotic sources, such as plant and animal cells, tissues and organs. The sample may also include diluents, buffers, detergents, and contaminating species, debris and the like that are found mixed with the one or more oligonucleotide(s) of interest. The sample may be “partially purified” (i.e., having been subjected to one or more purification steps, such as filtration steps) or may be obtained directly from a host cell or organism producing the one or more oligonucleotide(s) of interest (e.g., the sample may comprise harvested cell culture fluid).

In some embodiments, the sample matrix comprises at least one type of oligonucleotide. In some embodiments, the sample matrix comprises a cell culture, a cellular material, a cell extract or combination thereof.

In some embodiments, the sample matrix is clarified. That is, the sample has been subjected to a clarification step before the solid phase extraction. In some embodiments, the sample is lysed prior to extraction.

In some embodiments, the sample matrix is in the form of a solution. In some embodiments, the solution is heterogenous. In some embodiments, the solution is homogenous.

As used herein, the term “alkyl substituted amine” refers to an amine in which at least two hydrogen atoms are replaced with an alkyl substituent.

As used herein, the term “bridging alkyl substituted amine” refers to an alkyl substituted amine that connects two or more silyl groups, via an alkyl linker, that are capable of forming 1-3 siloxyl bonds per silyl group to the sorbent surface.

As used herein, the term “siloxyl” refers to a group having the formula ASi(Z₁Z₂Z₃), where n=2, 3, A designates an alkyl amine-containing moiety, and Z₁, Z₂ and Z₃ are independently selected from Cl, Br, I, C₁-C₄ alkoxy, C₁-C₄ alkylamino, and C₁-C₄ alkyl, although at most two of Z₁, Z₂ and Z₃ can be C₁-C₄ alkyl. In various embodiments, none of Z₁, Z₂ and Z₃ are C₁-C₄ alkyl (in other words, Z₁, Z₂ and Z₃ are independently selected from Cl, Br, I, C₁-C₄ alkoxy, and C₁-C₄ alkylamino). When n=2 or more, each of the Z₁Z₂Z₃ groups may be the same as each other, or each of the Z₁Z₂Z₃ groups may be different from one another.

As used herein, the term “terminal siloxyl groups” refers to siloxyl groups attached to the surface of sorbent material, where the siloxyl groups are connected to each other via a moiety that includes one or more bridging alkyl substituted amines.

As used herein, the term “alkyl” or “alkyl substituent” means a straight or branched saturated chain having 1 to 12 carbon atoms. Representative saturated alkyl groups include, but are not limited to, methyl, ethyl, n-propyl, isopropyl, 2-methyl-1-propyl, 2-methyl-2-propyl, 2-methyl-1-butyl, 3-methyl-1-butyl, 2-methyl-3-butyl, 2,2-dimethyl-1-propyl, 2-methyl-1-pentyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl, 2-ethyl-1-butyl, butyl, isobutyl, t-butyl, n-pentyl, isopentyl, neopentyl, n-hexyl and the like and longer alkyl groups such as heptyl, octyl and the like. Alkyl groups may be unsubstituted or substituted. Alkyl groups containing three or more carbon atoms may be straight chain or branched.

### The Sorbent Material

In one aspect, the present disclosure is directed to a sorbent material for performing solid phase extraction. The sorbent material comprises porous particles having a mean particle size greater than 5 μm and less than 100 μm, wherein the surface of the porous particles is modified with a ligand including one or more bridging alkyl substituted amines and at least two terminal siloxyl groups. That is, the surface of the porous particles is modified with dipodal or tripodal siloxyl groups that are connected through a molecule including one or more substituted amine(s).

In various embodiments, the ligand including one or more bridging alkyl substituted amines and at least two terminal siloxyl groups lacks alcohol moiety (e.g., —OH group).

In various embodiments, which can be used with any of the above aspects and embodiments, the ligand comprises less than 20 carbon atoms, less than 16 carbon atoms, less than 14 carbon atoms, less than 12 carbon atoms, less than 10 carbon atoms, less than 8 carbon atoms.

In some embodiments, the surface concentration of the ligands may range from 0.01 to 10.0 μmol/m², for example, 0.01, 0.05, 0.10, 0.30, 0.50, 1.0, 3.0, 5.0, 7.0, 9.0, or 10 μmol/m².

In various embodiments, the sorbent material is a porous anion exchange sorbent.

In various embodiments, which can be used with any of the above aspects and embodiments, the sorbent material comprises an inorganic material, an inorganic-organic hybrid material, an organic polymeric material, or a combination thereof.

In various embodiments, which can be used with any of the above aspects and embodiments, the sorbent material may comprise a silica-based material.

In various embodiments, which can be used with any of the above aspects and embodiments, the sorbent material may comprise inorganic-organic hybrid materials. Further inorganic-organic hybrid materials are described in U.S. Pat. No. 6,686,035B2, which is hereby incorporated by reference.

In some embodiments, porous particles are fully porous particles or superficially porous particles. In some embodiment, the sorbent of the present technology may be formed by hydrolytically condensing one or more alkoxysilane compounds. Examples of alkoxysilane compounds include, for instance, tetraalkoxysilanes (e.g., tetramethoxysilane (TMOS), tetraethoxysilane (TEOS), etc.), alkylalkoxysilanes such as alkyltrialkoxysilanes (e.g., methyl trimethoxysilane, methyl triethoxysilane (MTOS), ethyl triethoxysilane, etc.) and bis(trialkoxysilyl)alkanes (e.g., bis(trimethoxysilyl)methane, bis(trimethoxysilyl)ethane, bis(triethoxysilyl)methane, bis(triethoxysilyl)ethane (BTEE), etc.), as well as combinations of the foregoing. In certain of these embodiments, inorganic-organic hybrid silica-based materials may be prepared from two alkoxysilane compounds, for example, a tetraalkoxysilane such as TMOS or TEOS and an alkyl trialkoxysilane such as MTOS or a bis(trialkoxysilyl)alkane such as BTEE. When BTEE is employed as a monomer, the resulting materials are organic-inorganic hybrid materials, which are sometimes referred to as ethylene bridged hybrid (BEH) materials and can offer various advantages over conventional silica-based materials, including chemical and mechanical stability. One particular BEH material can be formed from hydrolytic condensation of TEOS and BTEE. In various embodiments, which can be used with any of the above aspects and embodiments, the exemplary porous sorbent is in the form of particles, typically spherical particles, having a diameter ranging from 1 to 100 μm. For example, the spherical particles can have a diameter of 1, 2, 5, 10, 25, 50, 70 or 100 μm.

In various embodiments, the porous sorbents described herein may have a pore size (average pore diameter) ranging from 75 to 2000 Angstroms, for example, 75, 100, 200, 500, 1000, or 2000 Angstroms as measured by conventional porosimetry methods. For sub-500 Angstrom pores, the average pore diameter (APD) can be measured using the multipoint N2 sorption method (Micromeritics ASAP 2400; Micromeritics Instruments Inc., Norcross, GA), with APD being calculated from the desorption leg of the isotherm using the BJH method as is known in the art. Hg porosimetry may be used for pores that are 500 Angstrom or greater as is known in the art.

In some aspects of the present disclosure, anion exchange sorbents such as those described herein may be provided in conjunction with a suitable housing (referred to herein as a “sorbent housing”). The sorbent and the sorbent housing may be supplied independently, or the sorbent may be pre-packaged in the sorbent housing, for example, in a packed bed. Sorbent housings for use in accordance with the present disclosure commonly include a chamber for accepting and holding sorbent. In various embodiments, the sorbent housings may be provided with an inlet and an outlet.

Suitable construction materials for the sorbent housings include inorganic materials, for instance, metals such as stainless steel and ceramics such as glass, as well as synthetic polymeric materials such as polyethylene, polypropylene, polyether ether ketone (PEEK), and polytetrafluoroethylene, among others.

In certain embodiments, the sorbent housings may include one or more filters which act to hold the sorbent in a sorbent housing. Exemplary filters may be, for example, in a form of membrane, screen, frit or spherical porous filter.

In certain embodiments, a solution received in the sorbent housing may flow into the sorbent spontaneously, for example, by capillary action. In certain embodiments, the flow may be generated through the sorbent by external forces, such as gravity or centrifugation, or by applying a vacuum to an outlet of the sorbent housing or positive pressure to an inlet of the sorbent housing.

Specific examples of sorbent housings for use in the present disclosure include, for example, a syringe, a single-use injection cartridge, a multiple-use cartridge applicable for on-line SPE at pressures up to HPLC pressures (˜5000 psi) or higher pressures compatible with UHPLC (˜20000 psi), a column, a multi-well device such as a 4 to 8-well rack, a 4 to 8-well strip, a 48 to 96-well plate, or a 96 to 384-well micro-elution plate, micro-elution tip devices, including a 4 to 8-tip micro-elution strip, a 96 to 384-micro-elution tip array, a single micro-elution pipet tip, a thin layer plate, a microtiter plate, a spin tube or a spin container.

In various embodiments, which can be used with any of the above aspects and embodiments, one or more bridging alkyl substituted amines have one or more pKa's ranging anywhere from 7.0 to 12. For example, in some embodiments, the pKa ranges between 7.0 and 8.5. In other embodiments, the pKa ranges between 7.0 and 11. In others, the pKa ranges between 8.5 and 10. In still others the pKa ranges from 8.5 to 11.5. Other ranges falling with the boundary of 7.0 and 12 are also possible, for example 7.5 to 9 or 8 to 10.5.

In various embodiments, the surface of exemplary sorbent material of the present disclosure is modified with a dipodal (e.g., two terminal groups) or tripodal (e.g., three terminal groups) siloxyl groups that is connected through one or more bridging alkyl substituted amines. Exemplary dipodal siloxyl groups possess two silicon atoms that can covalently bond to a surface (e.g., the surface of the porous particles). Exemplary tripodal siloxyl groups possess three silicon atoms that can covalently bond to a surface. After modification, at least one siloxyl terminal group is attached to the surface of porous particles through a covalent bond, e.g., Si—O bond (i.e., siloxy bond).

Sorbent materials possessing dipodal and/or tripodal siloxyl groups offer a distinctive advantage over conventional silanes in terms of maintaining the integrity of surface coatings under aggressive environmental conditions such as high pH (pH greater than 9) conditions. Without wishing to be bound by the theory, the improved durability of such siloxyl groups is associated with an increased crosslink density of the interphase and the inherent resistance to hydrolysis, as they can form up to six or nine, rather than three, Si—O bonds to the surface.

In strongly acidic and brine environments, dipodal or tripodal siloxyl groups of the present technology connected through one or more bridging alkyl substituted amines demonstrate improved resistance to hydrolysis compared to conventional silane coupling agents.

In various embodiments, which can be used with any of the above aspects and embodiments, the ligand that includes one or more bridging alkyl substituted amines and at least two terminal siloxyl groups that are attached to the surface of the sorbent material (e.g., the surface of the porous particles) includes less than 20 carbon atoms, less than 16 carbon atoms, less than 14 carbon atoms, less than 12 carbon atoms, less than 10 carbon atoms, less than 8 carbon atoms.

In some embodiments, one or more bridging alkyl substituted amines comprise amine groups such as secondary amine groups and/or tertiary amine groups, including, for example, —NHR₁ groups, —NR₁R₂ groups, and heterocyclic ring systems that contain at least one nitrogen atom, where R₁ and R₂ are independently selected from C₁-C₁₄ alkyl, C₂-C₁₄ alkenyl, C₂-C₁₄ alkynyl, C₃-C₁₄ cycloalkyl, C₃-C₁₄ heterocycloalkyl, C₆-C₁₄ aryl, or C₅-C₁₄ heteroaryl, for example, selected from C₁-C₄ alkyl, C₂-C₄ alkenyl, C₂-C₄ alkynyl, C₃-C₈ cycloalkyl, C₃-C₈ heterocycloalkyl, or C₆-C₁₂ heteroaryl, among others. Heterocyclic ring systems that contain at least one nitrogen atom may be selected, for example, from pyridyl, pyrimidinyl, pyridazinyl, pyrazinyl, piperidinyl, piperizinyl, hexahydropyrimidinyl, pyrrolyl, pyrazolyl, imidazolyl, pyrrolidinyl, pyrazolidinyl, imidazolidinyl, or triazinyl groups, among others.

In some embodiments, one or more bridging alkyl substituted amines may include a linking moiety that links the amine groups to the surface of porous particles. Examples of linking moieties, include those comprising hydrocarbon groups, for example, C₁-C₁₀ alkylene, C₂-C₁₀ alkenylene, C₂-C₁₀ alkynylene or C₆-C₁₀ arylene groups, in some embodiments, C₁-C₄ alkylene, C₂-C₄ alkenylene, C₂-C₄ alkynylene or C₆-C₁₀ arylene groups. In some embodiments, the linking moieties may comprise non-reactive, non-hydrocarbon groups (e.g., an amide group, ester group, sulfo group, ether group, carbamate group, urea group, etc.) positioned between two hydrocarbon groups (e.g., independently selected from C₁-C₁₀ alkylene, C₂-C₁₀ alkenylene, C₂-C₁₀ alkynylene or C₆-C₁₀ arylene groups, in some embodiments, C₁-C₄ alkylene, C₂-C₄ alkenylene, C₂-C₄ alkynylene or C₆-C₁₀ arylene groups).

In particular embodiments, the ligand including one or more bridging alkyl substituted amines and at least two terminal siloxyl groups is selected from one or more of the following: bis(3-trimethoxysilylpropyl)-N-methylamine; bis[3-(triethoxysilyl)propyl]amine; bis[4-(triethoxysilyl)butyl]amine; tris[3-(trimethoxysilyl)propyl]amine.

In one aspect, provided herein is a sorbent material for performing solid phase extraction. The sorbent material comprises porous silica particles having an average pore diameter greater than 200 Å and less than 400 Å and a mean particle size greater than 5 μm and less than 25 μm, wherein an exterior surface of each of the porous silica particles is modified with bis(3-trimethoxysilylpropyl)-N-methylamine.

### The Method for Extraction

Further provided herein is a method of extracting at least one of oligonucleotide from a sample matrix.

In one aspect, the present technology is directed to a method of performing solid phase extraction. This method comprises: (a) loading a sample fluid comprising one or more target oligonucleotides and at least one non-target component onto a sorbent material comprising porous particles having a mean particle size greater than 5 μm and less than 100 μm, wherein the surface of the porous particles is modified with a ligand including one or more bridging alkyl substituted amines and at least two terminal siloxyl groups, wherein the ligand comprises less than 16 carbon atoms, wherein at least one of the target oligonucleotides is retained by the sorbent; (b) flowing one or more washing solutions through the sorbent material, wherein the washing solutions remove at least one non-target component from the sorbent material while leaving at least one of the target oligonucleotides retained on the sorbent material; and (c) flowing one or more elution solutions though the sorbent material, wherein at least one of the target oligonucleotides retained on the sorbent material is released into one or more eluent solutions.

In one illustrative embodiment, in step (a), non-target components such as salts, sugars and large proteins are able to flow through the sorbent, while the target oligonucleotide(s) of interest, smaller proteins and lipids are bound to the sorbent via a mixed-mode, weak anionic interaction. In step (b), the non-target components (e.g., smaller proteins and lipids) are washed from the sorbent, while the target oligonucleotide(s) of interest remain bound to the sorbent. In step (c), the now-purified target oligonucleotide(s) of interest are recovered from sorbent.

In various embodiments, the pore size of the sorbent that is employed in the solid phase extraction methods may be selected based the length of at least one target oligonucleotide. For example, in embodiments where the one or more target oligonucleotide has/have a size ranging from 3 to 50 mer, a pore size ranging from 75 to 200 Angstroms may be selected. In embodiments where the one or more target oligonucleotide has/have a size ranging from 25 to 200 mer, a pore size ranging from 200 to 500 Angstroms may be selected. In embodiments where the one or more target oligonucleotide has/have a size ranging from 100 to 7000 mer, a pore size ranging from 500 to 2000 Angstroms may be selected.

In some embodiments, the porous particles are porous silica particles. In some embodiments, the porous silica particles are calcined porous silica particles. In other embodiments, the porous particles are porous silica/organic hybrid particles.

In some embodiments, at least one washing solution used in the solid phase extraction may comprise an organic solvent, typically, 20 vol % to 100 vol %. For example, the washing solution may contain 20 vol %; 40%; 60 vol %; 80 vol %; 90 vol %; 95 vol %; 98 vol %; 99 vol % or 100 vol % of an organic solvent such as methanol, acetonitrile or other common solvents used in reversed phase liquid chromatography. The washing solution may also include a salt such as up to 250 mM ammonium acetate, ammonium formate, or sodium chloride or other commonly used salts in ion exchange liquid chromatography, and be pH controlled—using ammonium acetate/formate or phosphate buffers or (semi)volatile buffers used in chromatography (e.g., morpholino buffers, ammonium acetate, triethylammonium acetate, etc.). In this regard, by using volatile buffers in the wash, the final eluent (extract) will contain as little non-volatile salt as possible. In some embodiments, the washing solution may have a pH ranging from 4 or less to 10 or more, for example, the washing solution may have a pH of 4, 5, 6, 7, 8, 9 or 10. The pH of the wash solution can be optimized for the particular porous anion exchange sorbent that is selected.

In some embodiments, the at least one elution solution used in the solid phase extraction may have a pH of at least 9, for example, ranging from 9 to 13, more typically, ranging from 9 to 12.

In some embodiments, the at least one elution solution used in the solid phase extraction may have a pH of at least 10, for example, ranging from 10 to 13, more typically, ranging from 10 to 12.

In some embodiments, at least one elution solution used in the solid phase extraction may comprise a polyphosphonic acid. The polyphosphonic acid may be, for example, a biphosphonic acid or a triphosphonic acid. The polyphosphonic acid may be selected, for example, from etidronic acid, clodronic acid, pamidronic acid, alendronic acid, neridronic acid, olpadronic acid, nitrilotri(methylphosphonic acid) or ethane-1,1,2-triphosphonic acid. In some embodiments, at least one elution solution may comprise a polyphosphonic acid in a concentration ranging from about 0.01 M to about 1 M. For example, the polyphosphonic acid may have a concentration of 0.01 M; 0.02 M; 0.05 M; 0.10 M; 0.20 M; 0.5 M; or 1 M.

In some embodiments, at least one elution solution used in the solid phase extraction may comprise one or more bases. The one or more bases may be selected from an organic amine, ammonium bicarbonate, ammonium hydroxide, or ammonium acetate. Organic amines include alkyl amines, for example, trimethyl amine, triethyl amine, or diisopropyl ethyl amine, among others.

In some embodiments, at least one elution solution used in the solid phase extraction may comprise one or more organic solvents. The one or more organic solvents may be selected, for example, from methanol, ethanol, hexafluoroisopropanol (HFIP) and/or tetrahydrofuran, among others.

In particular embodiments, at least one elution solution used in the solid phase extraction may comprise triethylamine (TEA), methanol and water, or the one or more elution solutions may comprise TEA, methanol, HFIP and water.

In some embodiments, after flowing the one or more elution solutions through the sorbent material, subjecting the one or more eluent solutions to liquid chromatography, mass spectrometry (MS), ultraviolet-visible spectroscopy, or combinations thereof.

In some embodiments, the one or more washing solutions comprises a partially aqueous organic solvent solution containing either methanol, ethanol, or tetrahydrofuran.

In some embodiments, the one or more elution solutions comprise a di, tri or tetravalent acid.

In some embodiments, the one or more elution solutions comprise one or more bases selected from an organic amine, ammonium bicarbonate, ammonium hydroxide, or ammonium acetate. In one embodiment, the one or more elution solutions comprise the organic amine TEA.

In some embodiments, the sample comprises biological fluids selected from whole blood samples, blood plasma samples, serum samples, oral fluids, cerebrospinal fluids, fecal samples, nasal samples, and urine, biological tissues such as liver, kidney and brain tissue, tissue homogenates, cells, or cell culture supernatants. In one embodiment, one or more target analyte is a double-stranded RNA, single-stranded RNA, single-stranded DNA, double-stranded DNA, double-standard RNA/DNA hybrid, synthetic RNA, synthetic DNA or combination therefore with a size ranging from a 10 mer to a 200 mer.

In some embodiments, the sample upon which the solid phase extraction is performed may be selected, for example, from biological fluids selected from whole blood samples, blood plasma samples, serum samples, oral fluids, cerebrospinal fluids, fecal samples, nasal samples, and urine, biological tissues such as liver, kidney and brain tissue, tissue homogenates, cells, or cell culture supernatants, among numerous other possibilities.

In some embodiments, the sample upon which the solid phase extraction is performed may be treated before loading the sample onto the porous anion exchange sorbent. For example, the sample may be treated with a denaturing agent. Suitable denaturing agents may be selected, for example, from proteases such as proteinase K, mass-spectroscopy-compatible surfactants, organic solvents, urea, guanidine, or a substituted guanidine.

In further aspects of the present disclosure, kits useful in performing solid phase extraction procedures may be provided. In various embodiments, the present disclosure provides kits that comprise an exemplary sorbent such as any of those described hereinabove, among others, a housing for the sorbent, such as any of those described hereinabove, among others, and one or more kit components selected from the following: (a) a denaturant solution, such as any of those described hereinabove, among others, (b) an elution solution, such as any of those described hereinabove, among others, (c) a washing solution, such as any of those described hereinabove, among others, (d) a collection plate or collection vial, (c) a cap mat, (f) calibration and reference standards, (g) instructions for use, and (h) optionally identification tagging for each component, which may include passive tags, such as radio-frequency identification (RFID) tags, for tracking the components.

### EXAMPLES

### Example 1—Preparation of SPE Sorbents

The surface of fully porous silica particles was modified by refluxing the particles in toluene and an ionizable silane, 3-(diethylamino)propyltrimethoxysilane (DEAP) or bis(3-trimethoxysilylpropyl)-N-methylamine (BPMA, Bispropylmethylamine), for 2 h under anhydrous conditions. The particles were isolated via filtration then washed successively with toluene, acetone/water (1:1 v/v), and acetone. The isolated particles were dried for 16 h at 80° C. under 25 mm vacuum. The surface coverage of the ionizable dopant was calculated using the difference in particle % N after surface modification as measured by elemental analysis (Table 1). Before surface modification, the fully porous silica particles had a mean particle size of 17.5 μm, a surface area of 124 m²/g, a pore volume of 1.03 cc/g, an average pore diameter of 293 Å, and a skeletal density of 2.2 g/cm³.

TABLE 1
Properties of fully porous modified silica particles

| Sample | Silane | Silane Charge | Surface Coverage |
|---|---|---|---|
| ID | Type | (μmol/m²) | (μmol/m²) |
| 1a | DEAP | 1.5 | 1.38 |
| 1b | BPMA | 1.5 | 1.32 |
| 1c | BPMA | 2.0 | 1.45 |
| 1d | BPMA | 1.0 | 0.91 |

### Example 2—Dissolved Silicate Testing

The surface modified particles from Example 1 (1a and 1b) as well as their silica precursor were exposed to high pH conditions (1/1 v/v˜1 mM NaOH/MeOH; 25 mL/g) for 15 minutes at RT—The particles were isolated via filtration; the filtrate was collected and tested by ICP-MS to quantify the presence of dissolved silicates. Controls were also tested to quantify silicon contributions from the stock solution and filter apparatus. All were found to contain <0.2 ppm Si. The filtrate from the dipodal doped prototype (2c; BPMA) was found to contain nearly half of the dissolved silicates compared to the monopodal doped prototype (2b; DEAP), indicating twice the hydrolytic stability under the tested conditions (Table 2). The filtrate of the dipodal prototype also contained 38% less silica compared to the bare (unbonded) silica (2a), indicating additional protection of the base silica particle.

TABLE 2
Concentration of dissolved silicates after exposure to high pH conditions

| Sample ID | Precursor ID | Surface Modification | Silica (ppm) |
|---|---|---|---|
| 2a | — | None | 5.2 |
| 2b | 1a | DEAP | 6.3 |
| 2c | 1b | BPMA | 3.2 |

The hexa-functionality of dipodal silanes, allows for enhanced hydrolytic stability over its conventional tri-functional monopodal counterparts, though improved adhesion to the particle surface due to doubling the quantity of possible siloxyl bonds. Increasing the number of bonds to the particle surface from three to six makes complete removal of the ligand more difficult. While not wishing to be bound by theory, the combination of the hexa-functionality and bridging characteristic of the BPMA silane also protects against erosion of the silica base particle due to its constrained placement on the particle surface.

### Example 3—High pH Stability Testing of Sorbents

Sorbents were packed into 2.1×50 mm stainless steel hardware columns and tested for electrostatic properties via separations of trimethylphenylammonium (TMPA). Void volumes of the columns were measured using a 70/30 acetonitrile/water mobile phase, 0.1 mL/min flow rate and injections of acenaphthene (1 μL of a 2.5 mg/mL stock solution) or thiourea (Table 4). Following the void volume measurement, the mobile phase was switched to a 10 mM dichloroacetate ammonium hydroxide pH 8.5 buffer. Separations were then performed on 1 μL injections of 6.25 mg/mL TMPA under room temperature conditions using a 0.1 mL/min flow rate. Chromatograms corresponding to 7 column volumes were acquired with UV detection at 254 nm, and 25 repeat analyses were performed.

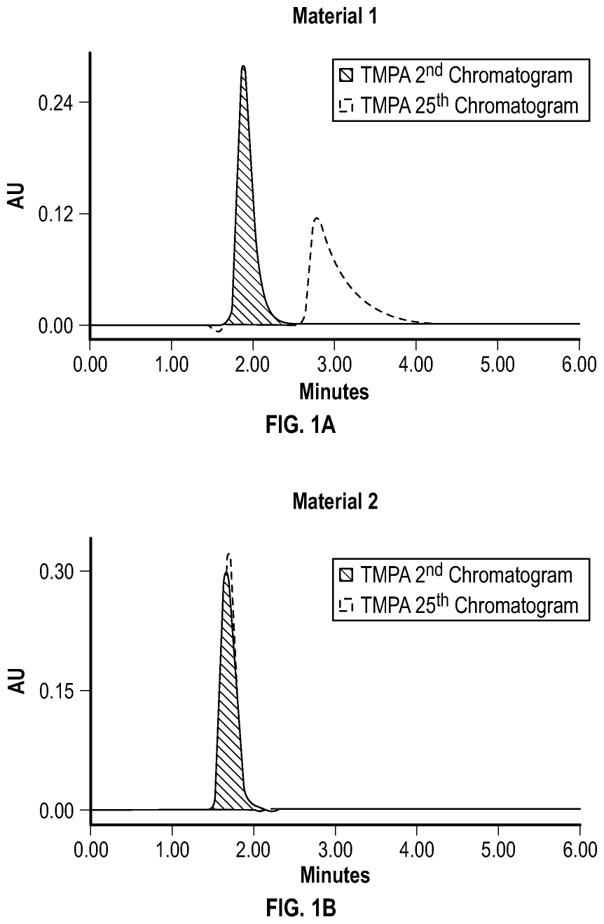

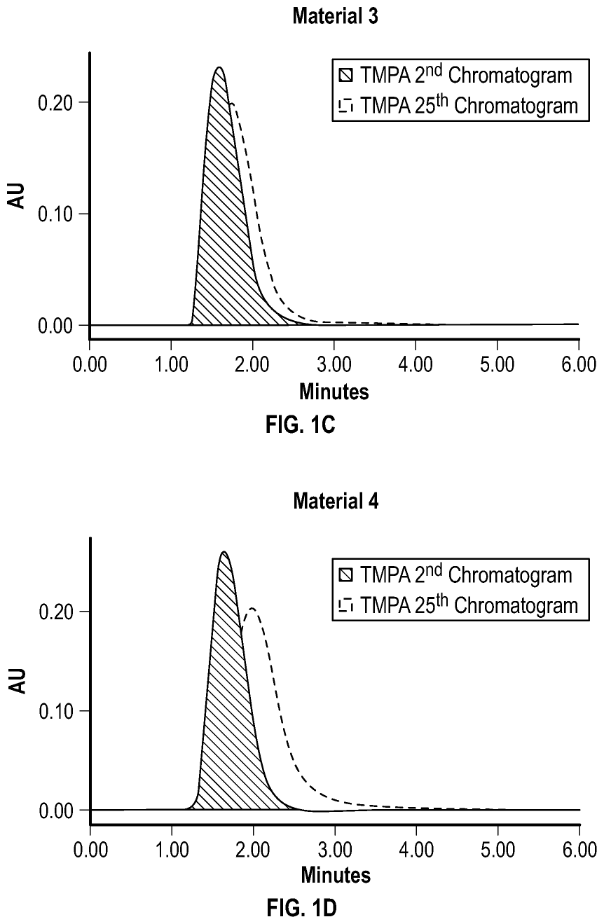

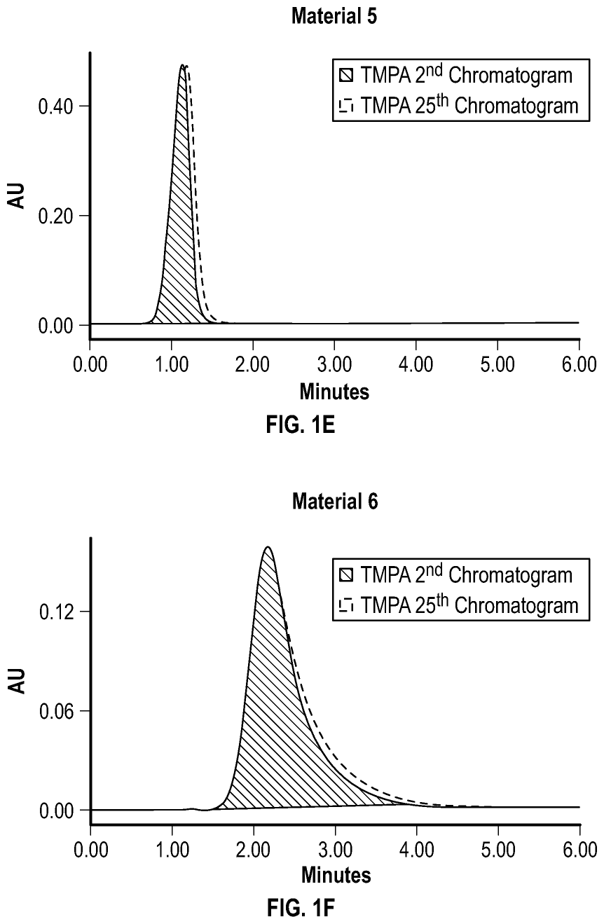

The stability of the surface chemistry is evaluated by observing the change in TMPA retentivity. DEAP doped sorbent (Material 1) showed signs of instability over repeat injections at pH 8.5 (e.g., retention time and k drift, loss of 5 Sigma efficiency and EP plate count, increased USP tailing)(FIG. 1A). Other tested silica-based sorbents show instability too whether they were based on DEAE bonding or a PEI surface chemistry (FIG. 1C and FIG. 1D). The BPMA doped prototype (Material 2) (FIG. 1B) appeared to be significantly more stable under the same conditions as it showed little to no change for TMPA retentivity.

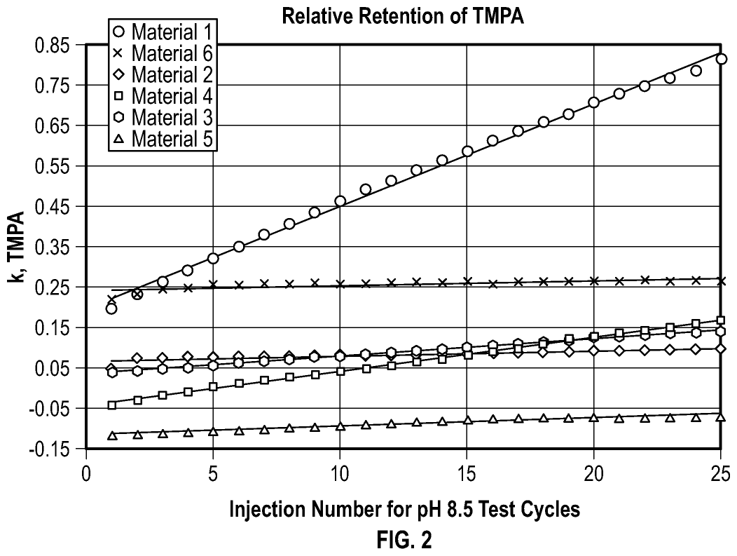

Polymeric material such as Material 5 showed little to no change (FIG. 1E). Material 6 is a wide pore hydrophilic lipophilic co-polymer of N-methylpyrrolidone and divinylbenzene that is also functionalized with a diethyl substituted tertiary amine. It too showed little to no change for TMPA retentivity (FIG. 1F). In sum, the use of dipodal silane bonding to functionalize a silica-based material with an ion exchanger has proven to be a very effective and controlled means of creating a chemically stable SPE sorbent that is as stable a polymeric equivalent. Linear correlation can be fitted to the change in TMPA retentivity data (FIG. 2). With this data analysis, it can be seen that the slope of change per 7 column volumes was 0.0012 and 0.0013 for Materials 6 and 2, respectively (FIG. 2). Other materials showed steeper slopes and percent rate of change. Materials 3, 4, and 5 showed slopes of 0.0043, 0.0085, and 0.0021, respectively (FIG. 2).

TABLE 3
Properties of Materials 1-10

| | | | | | Silane |
|---|---|---|---|---|---|
| | Particle | Pore | | | Bonding |
| | Size | Size | | | Coverage |
| Sorbent | (μm) | (Å) | Base Particle | Surface Chemistry | (μmol/m²) |
| Material 1 | 20 | 300 | Calcined high purity | Diethylaminopropyl | 1.38 |
| | | | silica | (DEAP) | |
| Material 2 | 20 | 300 | Calcined high purity | Bispropylmethylamine | 1.32 |
| | | | silica | (BPMA) | |
| Material 3 | 35 | 300 | Silica | Diethylaminoethyl | Unknown |
| (SMT DEAE) | | | | (DEAE) | |
| Material 4 | 35 | 300 | Silica | Polyethylenimine (PEI) | Unknown |
| (SMT WAX) | | | | | |
| Material 5 | 36 | 500 | Hydroxylated | DEAE grafting | silane |
| (Nano Micro | | | polymethacrylate | | coverage not |
| UniDEAE 30S) | | | | | applicable |
| | | | | | (n/a) |
| Material 6 | 55 | 300 | Co-polymer of N- | Diethyl tertiary amine | silane |
| (Nano Micro | | | methylpyrolidone and | | coverage not |
| UniBPC 55 | | | divinylbenzene | | applicable |
| WAX) | | | (NMP-DVB) | | (n/a) |
| Material 7 | 70 | Unknown | Silica | Methyl amino ethanol | Unknown |
| (Machery | | | | | |
| Nagel ™ | | | | | |
| NucleoBond ™ | | | | | |
| Xtra) | | | | | |
| Material 8 | 50 | 1000 | Methacrylate | Diethylaminoethyl | silane |
| (BioRad | | | | (DEAE) | coverage not |
| MacroPrep ® | | | | | applicable |
| DEAE) | | | | | (n/a) |
| Material 9 | 60 | 80 | Polyvinylpyrolidone | Piperazine | silane |
| (Waters Oasis ™ | | | copolymer | | coverage not |
| WAX) | | | | | applicable |
| | | | | | (n/a) |
| Material 10 | 33 | 85 | Polystyrene | Pentylethylenehexamine | silane |
| (Phenomenex | | | divinylbenzene (PS- | | coverage not |
| Clarity ® | | | DVB) | | applicable |
| OTX ™) | | | | | (n/a) |

TABLE 4
Instrument Method for High pH Stability Testing
System: ACQUITY UPLC H-Class system
Mobile phase for void volume measurement:
Acetonitrile/Water (70/30, v/v)
Test mobile phase: 10 mM Dichloroacetic Acid, adjusted
pH 8.5 with 30% Ammonium Hydroxide
Column dimension: 2.1 × 50 mm
Flow rate: 0.1 mL/min
Injection Volume: 1 μL
Detector: UV @ 227 and 254 nm
Strong/weak needle wash: Water
Seal wash: Isopropanol/Water (70/30, v/v)
Column/Sample Temp (° C.): Off

### Example 4—WAX SPE Comparative Examples

The usability of the BPMA silica sorbent (Material 2) was further tested and compared to other sorbents. Sorbents were prepared for this testing by being packed into 4 mg wells of a microelution plate (identical to that used in Waters part number 186008052). A test mixture comprised of a 20-mer T7 promoter PCR primer, naphthalene sulfonic acid (NSA), and bovine serum albumin (BSA) was used as a means to investigate selectivity.

To begin, a 4 mg bed of sorbent was equilibrated with two, 200 μL volumes of ammonium acetate, pH 5.5. The text mixture sample was then mixed in equal volume with 100 mM ammonium acetate pH 5 and 500 mM guanidinium hydrochloride and thereafter loaded onto the bed to be tested. The loaded sample was next washed with a single 200 μL volume of 30% methanol. The sample was subsequently eluted from the sorbent with two 50 μL volumes of an eluent comprised of 50 mM etidronic acid and 50 mM triethylamine in 80:20 water/methanol that had been titrated to pH 11.5 with ammonium hydroxide.

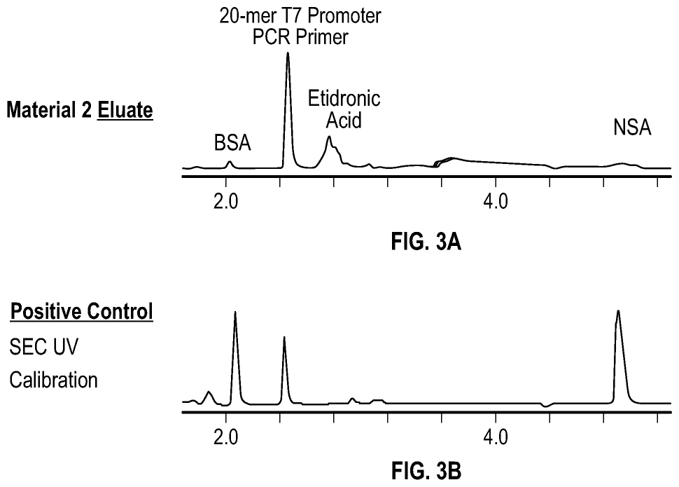

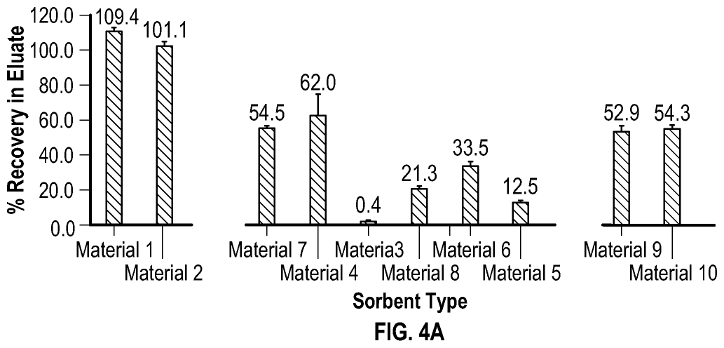

Collected eluates were assayed by SEC-UV analysis to determine the recovery of the 20-mer oligonucleotide and the % composition of the eluate (e.g., its purity) (Table 5). An example SEC chromatogram for the Material 2 eluate and for a control standard is provided in FIG. 3A and FIG. 3B, respectively. In total, 10 different sorbents (materials 1-10) were tested in this manner using triplicate analyses. Materials 3-10 are commercially available WAX sorbents, e.g., WAX sorbents available from competitors (Table 3). These sorbents used in this comparative example includes silica bonded with diethylaminoethyl ligands (DEAE, available from Separation Methods Technologies, Newark, DE), silica bonded polyethylenimine ligands (WAX, available from Separation Methods Technologies (SMT), Newark, DE), UniDEAE-30S (available from Suzhou NanoMicro Technologies, China), UniBPC 55-WAX (available from Suzhou NanoMicro Technologies, China), Machery Nagel™ NucleoBond™ Xtra (available from Macherey-Nagel GmbH& Co. KG Germany), BioRad MacroPrep® DEAE (available from Bio-Rad Laboratories, Inc., USA), WAX Oasis™ (available from Waters, Milford, MA), and Clarity® OTX™ (Phenomenex, Torrance, CA).

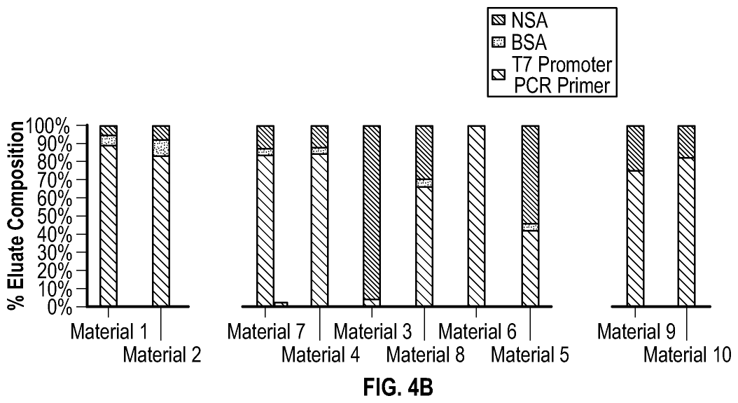

Using a calibrant for the SEC UV response, the amounts of each sample component were determined. Histograms reporting average % recovery of the 20-mer T7 promoter PCR primer is shown in FIG. 4A along with a stacked bar chart that shows the percent composition (FIG. 4B) of the obtained eluate (as broken down to relative amounts of the oligonucleotide versus BSA and NSA). Very high recovery of the 20-mer oligo was achieved along with excellent accuracy and precision when the SPE procedure was performed with Material 2. Meanwhile, a DEAP bonded sorbent (Material 1) also showed high recovery, but this material exhibited poorer reproducibility. None of the other sorbents produced oligo recoveries greater than 70%. The Material 2 SPE eluate is noted to have contained slightly higher relative amounts of BSA and NSA versus other sorbents, but its high levels of oligo recovery are unmatched, and this is believed to be an acceptable compromise and can be further optimized with method development work that caters to specific applications and matrices.

TABLE 5
Instrument Method for SEC UV Testing
System ACQUITY UPLC H-Class
Column: Premier Protein BEH 250 SEC 1.7 μm, 4.6 × 150 mm
Detector: UV @ 260 nm
Mobile phase: 200 mM Ammonium Acetate pH 6.8 +
10% ACN
Flow rate: 0.6 mL/min
Injection volume: 10 μL
Sample Temperature: 6° C.
Run time: 7 minutes

### Example 5—BPMA WAX SPE Batch Reproducibility and Robustness (Low and High Coverage BPMA Coverages)

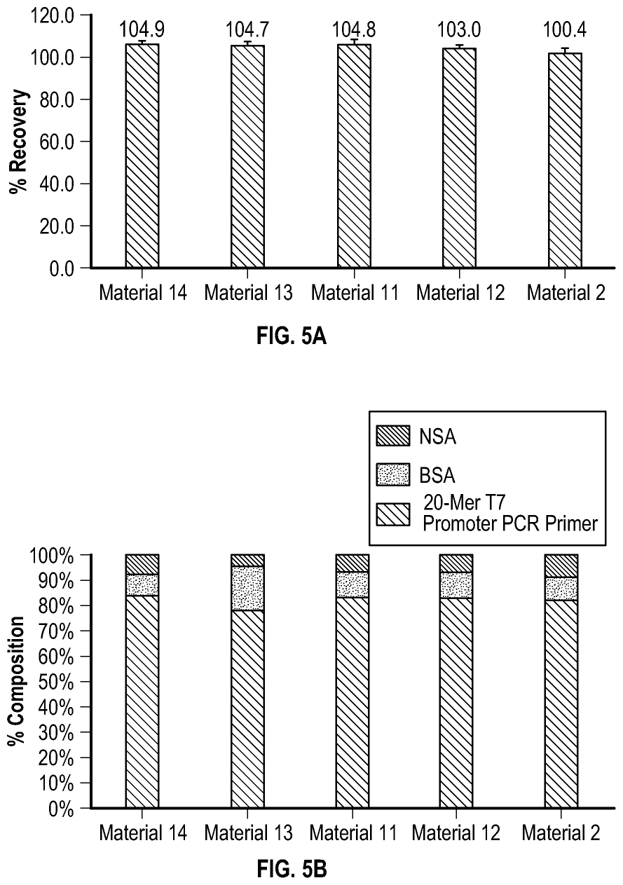

SPE tests with T7 promoter PCR primer, BSA and NSA were also applied to reproduced batches of Material 2 (Materials 11 and 12) as well as Material 2-like materials that were purposely prepared to have 33% lower and 33% higher anion exchanger surface coverages (Materials 13 and 14, respectively). Table 6 lists the properties of these other sorbents. As shown in FIG. 5A-5B, SPE results were most comparable no matter the type of BPMA silica-based sorbent employed. One exception is in the amount of BSA that was eluted from Material 13, the low coverage˜1.0 μmol/m² comparison sorbent.

TABLE 6
The properties of exemplary sorbents

| | Par- | | | | Silane |
|---|---|---|---|---|---|
| | ticle | Pore | | | Bonding |
| | Size | Size | | | Coverage |
| Sorbent | (μm) | (Å) | Base Particle | Surface Chemistry | (μmol/m²) |
| Material | 20 | 300 | Calcined high | Bispropylmethylamine | 1.3 |
| 2 | | | purity silica | (BPMA) | |
| Material | 20 | 300 | Calcined high | Bispropylmethylamine | ~1.5 |
| 11 | | | purity silica | (BPMA) | |
| Material | 20 | 300 | Calcined high | Bispropylmethylamine | ~1.5 |
| 12 | | | purity silica | (BPMA) | |
| Material | 20 | 300 | Calcined high | Bispropylmethylamine | ~1.0 |
| 13 | | | purity silica | (BPMA) | |
| Material | 20 | 300 | Calcined high | Bispropylmethylamine | ~2.0 |
| 14 | | | purity silica | (BPMA) | |

### Example 6—WAX SPE Used to Extract an Oligonucleotide from a Biofluid

Materials 1 through 6 have also been applied to the extraction of an antisense oligonucleotide from biofluid. A sample of this sort was created by mixing 994 μL rat plasma with 1 μL of 10 mg/mL Trecovirsen. Trecovirsen is a 25-mer antisense oligodeoxynucleotide phosphorothioate.

200 μL of the Trecovirsen spiked rat plasma was diluted with 40 μL of 6M guanidinium hydrochloride in 60 mM pH 7.5 Tris buffer, 40 μL 20 mM dithiothrietol and 50 μL proteinase K (Qiagen, part number 19131). This mixture was vortexed and subsequently incubated at 65° C. for 15 minutes.

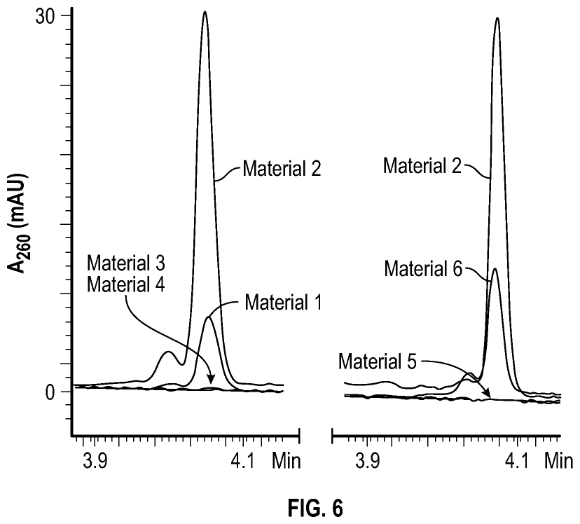

Solid phase extraction was next performed using a microelution plate packed with 4 mg sorbent beds and a positive pressure manifold. Each sorbent bed was first conditioned with two 200 μL volumes of methanol and then equilibrated with two, 200 μL volumes of 50 mM ammonium acetate pH 5.5 buffer. To these condition beds, samples were loaded and washed with another two 200 μL volumes of 50 mM ammonium acetate pH 5.5 buffer as well as one, 300 μL volume of 30% methanol. Finally, the adsorbed and purified trecovirsen was eluted from the SPE wells using two, 50 μL volumes of an eluent comprised of 50 mM triethylamine in 50% methanol. The resulting samples were directly injected onto ion pairing reversed phase chromatography and detected by UV absorbance at a 260 nm wavelength (Table 7). FIG. 6 presents the chromatograms for trecovirsen as extracted from rat plasma using Materials 1 through 6 as SPE sorbents. As shown, Material 2 yielded significantly higher signal the trecovirsen antisense oligonucleotide.

TABLE 7
Instrument Method for IP-RPLC-UV of Trecovirsen
Instrument: Acquity UPLC I-Class
Detection: UV @ 260 nm
Column: Premier Oligo BEH C18 130Å 1.7 μm 2.1 × 150 mm
Flow rate: 0.2 mL/min
Column Temperature: 60° C.
Mobile phase A: 1.0% 1,1,1-hexafluoroisopropanol
(HFIP), 0.1% diisopropylethylamine (DIPEA) in water
Mobile phase B: 0.75% HFIP, 0.0375% DIPEA
in 65% ACN and 35% water
Gradient: 5-25% B in 5 min

While this disclosure has been particularly shown and described with reference to example embodiments thereof, it will be understood by those skilled in the art that various changes in form and details may be made therein without departing from the scope of the technology encompassed by the appended claims.

1. A sorbent material for performing solid phase extraction, the sorbent material comprising porous particles having a mean particle size greater than 5 μm and less than 100 μm, wherein the surface of the porous particles is modified with a ligand that includes one or more bridging alkyl substituted amines and at least two terminal siloxyl groups, wherein the ligand comprises less than 16 carbon atoms.

2. The sorbent material of claim 1, wherein the terminal siloxyl group is derived from a bis, trifunctionally activated silylpropyl N-methylamine silanization reagent.

3. The sorbent material of claim 1, wherein the terminal siloxyl group is derived from bis(3-trimethoxysilylpropyl)-N-methylamine.

4. The sorbent material of claim 1, wherein the sorbent material maintains hydrolytic stability over a pH range of about 8.5 to about 12.

5. The sorbent material of claim 1, wherein the porous particles are porous silica particles.

6. (canceled)

7. The sorbent material of claim 1, wherein the porous particles are porous silica/organic hybrid particles.

8. The sorbent materials of claim 1, wherein the porous particles have a ligand surface concentration from about 0.05 μmol/m² to about 5.0 μmol/m².

9. The sorbent materials of claim 1, wherein the porous particles have an average pore diameter of between 150 and 1000 Å.

10. The sorbent material of claim 1, wherein the one or more bridging alkyl substituted amines comprises one or more pKa values greater than 7 and less than 10.5.

11. The sorbent material of claim 1, wherein the ligand comprises less than 12 carbon atoms.

12.-15. (canceled)

16. A method of performing solid phase extraction comprising:
a) loading a sample fluid comprising one or more target oligonucleotides and at least one non-target component onto a sorbent material comprising porous particles having a mean particle size greater than 5 μm and less than 100 μm, wherein the surface of the porous particles is modified with a ligand that includes one or more bridging alkyl substituted amines and at least two terminal siloxyl groups, wherein the ligand comprises less than 16 carbon atoms, wherein at least one of the one or more target oligonucleotides is retained by the sorbent;
b) flowing one or more washing solutions through the sorbent material, wherein the washing solutions remove at least one non-target component from the sorbent material while leaving at least one of the one or more target oligonucleotides retained on the sorbent material; and
c) flowing one or more elution solutions though the sorbent material, wherein at least one of the one or more target oligonucleotides retained on the sorbent material is released into one or more eluent solutions.

17. The method of claim 16, after flowing the one or more elution solutions through the sorbent material, subjecting the one or more eluent solutions to liquid chromatography, mass spectrometry (MS), ultraviolet-visible spectroscopy, or combinations thereof.

18. The method of claim 16, wherein the one or more washing solutions comprises a partially aqueous organic solvent solution containing either methanol, ethanol, or tetrahydrofuran.

19. The method of claim 16, wherein the one or more elution solutions have a pH ranging from 8.5 to 12.

20. The method of claim 16, wherein the one or more elution solutions comprise a di, tri or tetravalent acid.

21. The method of claim 16, wherein the one or more elution solutions comprise one or more bases selected from an organic amine, ammonium bicarbonate, ammonium hydroxide, or ammonium acetate.

22. The method of claim 16, wherein the one or more elution solutions comprise the organic amine triethylamine (TEA).

23. The method of claim 16, wherein the sample comprises biological fluids selected from whole blood samples, blood plasma samples, serum samples, oral fluids, cerebrospinal fluids, fecal samples, nasal samples, and urine, biological tissues such as liver, kidney and brain tissue, tissue homogenates, cells, or cell culture supernatants.

24. The method of claim 16, wherein one or more target analyte is a double-stranded RNA, single-stranded RNA, single-stranded DNA, double-stranded DNA, double-stranded RNA/DNA hybrid, synthetic RNA, synthetic DNA or combination therefore with a size ranging from a 10 mer to a 200 mer.

25. The method of claim 16, wherein the porous particles are porous silica particles, or wherein the porous particles are porous silica/organic hybrid particles.

26.-28. (canceled)
